(19) United States
(12) Patent Application Publication
(10) Pub. No.: US 2004/0230497 A1
(43) Pub. Date: Nov. 18, 2004

(54) Global marketing data system

(76) Inventor: Jeffrey William Tripp, Annandale, NJ (US)

Correspondence Address: IP DEPARTMENT OF PIPER RUDNICK LLP, ONE LIBERTY PLACE, SUITE 4900, 1650 MARKET ST, PHILADELPHIA, PA, 19103, US

(21) Appl. No.: 10/843,171

(22) Filed: May 11, 2004

Related U.S. Application Data
(60) Provisional application No. 60/469,901, filed on May 13, 2003.

(51) Int. Cl. G06F 17/60

(52) U.S. Cl. 705/26

(57) ABSTRACT

A means/product seamlessly gathers and retains data for consumer products and services to enable e-commerce in handheld devices. Data is available at the product and rich enough in content to provide details about the product or service for use in the purchasing decision of the consumer or immediately allow access to additional information through a wireless connection. In one embodiment, the solution utilizes RFID tag technology.

### CROSS-REFERENCE TO RELATED APPLICATIONS

The present application claims priority of U.S. Provisional patent application Serial No. 60/469,901 filed May 13, 2003, the entire disclosure of which is incorporated by reference herein.

### BACKGROUND OF THE INVENTION

There exists an application for RFID technology that has gone unnoticed and provides a business opportunity to create products for the consumer market that complements the efforts of the retailers and enables efficient electronic/mobile commerce (e-commerce) opportunities. This application will provide consumers with valuable point of service information and will support the retailers' efficiency goals and the manufacturers brand awareness, while providing technical simplicity and helping to create more value for RFID devices by creating the broadest application of the technology that is possible. The following information is an overview of this new business opportunity.

It is possible to create a product and service to leverage the deployment of the next generation RFID tags and provide consumers with a simple, affordable, and interactive wireless data link to download product specifications or information to handheld devices seamlessly, while providing retailers with an efficient mode of e-commerce.

### SUMMARY OF THE INVENTION

Consumers have many handheld devices available that can be used to store data and information or access information remotely. Today, this information is stored in a detached way for close association for the consumer to use effectively or in not enough detail to prove effective. If more information was immediately and seamlessly available for the consumer, this data could be used to provide details about products, enhance services, or provide directions. Having this information would create more awareness for the consumer and allow for faster purchasing decisions to be made. Allowing products to be updated with this latest information can assist the product marketing teams in point of sale advertising and provide a new tool in their quest to optimize the product flow through the channels.

The following discussion introduces a concept for information gathering and applications for its use. The information is focused on products, although, there are service applications and business opportunities also available, as previously discussed. The technological aspects will be discussed in the following section.

### BRIEF DESCRIPTION OF THE DRAWINGS

FIG. 1 is an exemplary diagram in accordance with an embodiment of the present invention.

FIG. 2 is an exemplary diagram in accordance with an embodiment of the present invention.

FIG. 3 is an exemplary diagram in accordance with an embodiment of the present invention.

FIG. 4 is an exemplary block diagram in accordance with an embodiment of the present invention.

FIG. 5 is an exemplary block diagram in accordance with an embodiment of the present invention.

### DETAILED DESCRIPTION

It is proposed to introduce a means/product to seamlessly gather and retain data for consumer product and services to enable e-commerce in handheld devices. Data would be immediately available at the product and be rich enough in content to provide details about the product or service for use in the purchasing decision of the consumer or immediately allow access to additional information through a wireless connection. The proposed solution would tap into the emerging RFID tag technology. The consumer would either purchase add-on products for wireless products such as PDA's, (portable handheld devices) and cellular phones or purchase a handset with access capability included. The modules would interface directly to these handheld devices, tapping into an already embedded base. The consumer, on demand, would operate the devices/reader. This would be accomplished by having the consumer approach a product of interest and wave their handheld device near the product to extract the information provided. The data would be loaded into the handheld unit for review, storage, or seamless data access through a wireless data link. The transaction is simple and efficient, but yet provides information to the consumer that could be valuable in making a purchase, at the point of sale.

Manufacturers or retailers would embed/attach RFID tags into their products. As the devices are programmable, the both the retailer or the manufacturer could modify the contents of the device to provide up to date information about a product that would be useful to the consumer on top of the baseline information such as product features, model numbers, etc. In fact, the RFID tags memory can be scaled to provide increasing content for more sophisticated or expensive items. Additionally, the client software would also create a data link, allowing the consumer to immediately access more information. All of this would take place automatically, after the consumer decides to look for additional information.

The retailer and manufacturer would now have at their disposal, a powerful new marketing tool. Now that information can be updated in real-time for the consumer, marketing teams can test different forms of content at the point of sale to sway the thoughts of the consumer.

To promote the use of this e-commerce method the new business would design ID readers to be integrated or added onto portable handheld devices. This would provide consumers to have this option available in many forms such as mobile phones, personal PDA's or possibly shopping carts with readers embedded.

To implement this concept.

1) Reader and the associated content in the RFID tag

2) Client software residing on the handheld device

3) Carrier grade software to create efficient data connections

4) Database service and web-based database software.

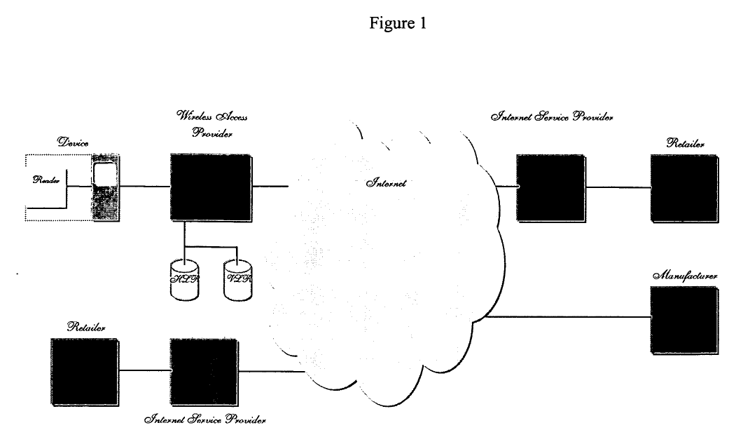

The diagram in FIG. 1, is a simple system representation. Contained within the Internet cloud are the routers and access devices that create the connections throughout the network. As this business is developed, it is important to recognize that several operating environments exist and must be addressed.

As the user demands greater and greater seamless content, the global environment will be entered. At this level, there is a wide range of software and services to be offered. As access encompasses all entities including the retailers and manufacturers, client software or services is required to allow efficient use of this new capability. As users seamlessly enter into this environment, applications can range from information exchange to video clip demonstrations to live broadcasts with video. This is dependent upon the level of service required by each entity. Maintenance and access to data bases to support these activities must be provided and connected seamlessly.

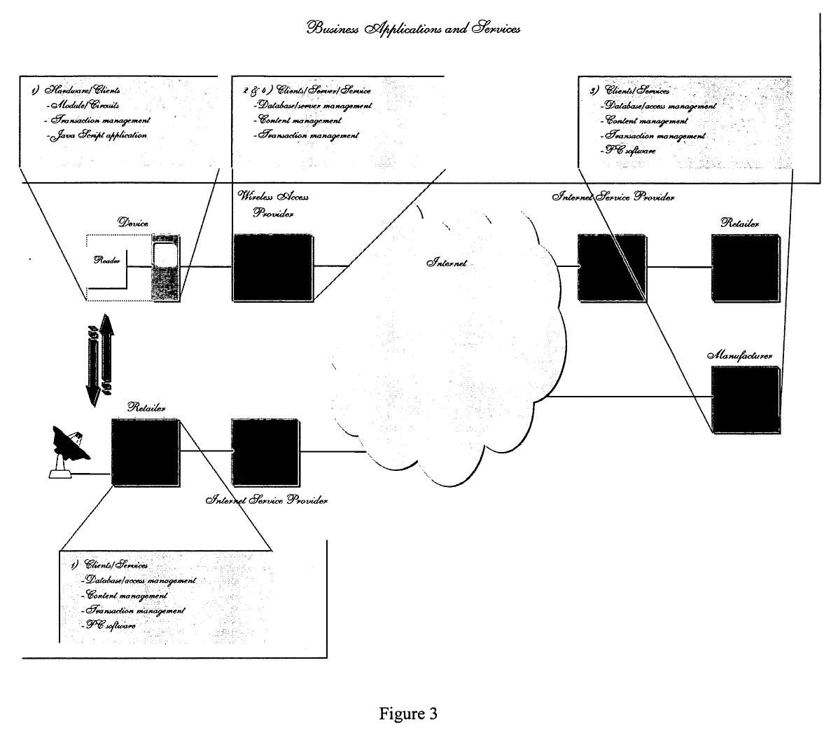

It is appropriate then to develop and offer multiple levels of service and software to support the many varied applications for this business as shown in FIG. 3. Client software will reside in many parts of the system, offering unique marketing capabilities. Software clients/applications will be available for the manufacturer and retailer to access data bases of product information or content, included in this will be the capability to format, design and scale the content to work reliable with the limited displays available on handheld devices. Also, this software will be secure and capable of conducting transactions directly to these entities.

Generally, the system as described is very flexible and can be implemented using technology that is available today. It offers capabilities to expand the content through RFID tags (in any band, though UHF and microwave are highlighted for use with a handheld device such as a cellphone) with more memory as they technology is improved or provides seamless access to predetermined content for the user to review.

In the previous sections, it was demonstrated that a technology could be developed to deliver new and unique products and services to the consumer. The system is flexible and lends itself to leverage future technical advances enhancing the capabilities and potential of the entire system allowing ongoing revenue sources, also. To describe the opportunity appropriately, each of the systems elements will have to be broken down and the revenue stream in each area will be analyzed. Further, additional models will be introduced describing the transaction capabilities this technology offers along with descriptions detailing the benefits achieved within each product sector. Note, though, the market approach in each sector will vary along with the opportunity. Again, the applications and flexibility of this system is substantial allowing adaptation to meet a variety of customer and consumer needs.

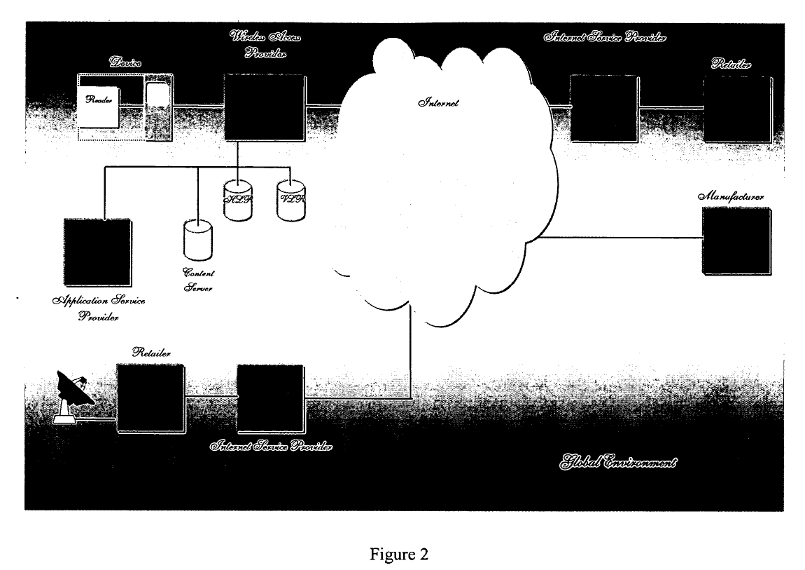

First, the system diagram, as shown in FIG. 2, will be used to identify products and models. This can be generally divided into the following partitions:

1) Hardware modules, chips, circuits, clients, and IP to support the handheld reader.

2) Local environment software clients, PC software, network software and marketing services for the retailer.

3) Global environment marketing service, network software for the retailer or manufacturer.

4) Content server software/hardware for the wireless access provider or application service provider.

Referring to FIG. 3, the first area to consider is the reader itself, the modules, circuits, clients and intellectual property licensing. The first goal is to create a community of handheld devices that have the capability to access RFID tags and create the appropriate links to drive the content server. This can be achieved in several methods. First, completely new modules are created that clip, interface, or integrate to a handheld device. These devices are manufactured and made available as retail items and sold both directly or through retail chains. Further, some of these handheld devices already contain Bluetooth or 802.11 capabilities. These users actually provide a great opportunity, as the module circuitry cost is already sunk by the consumer in their handset and all they need to purchase is the client software to operate and access the RFID tag to enjoy the full capabilities of the system. The users will be able to access this capability directly from their handheld devices and download the client from our web-server on a fee-based basis.

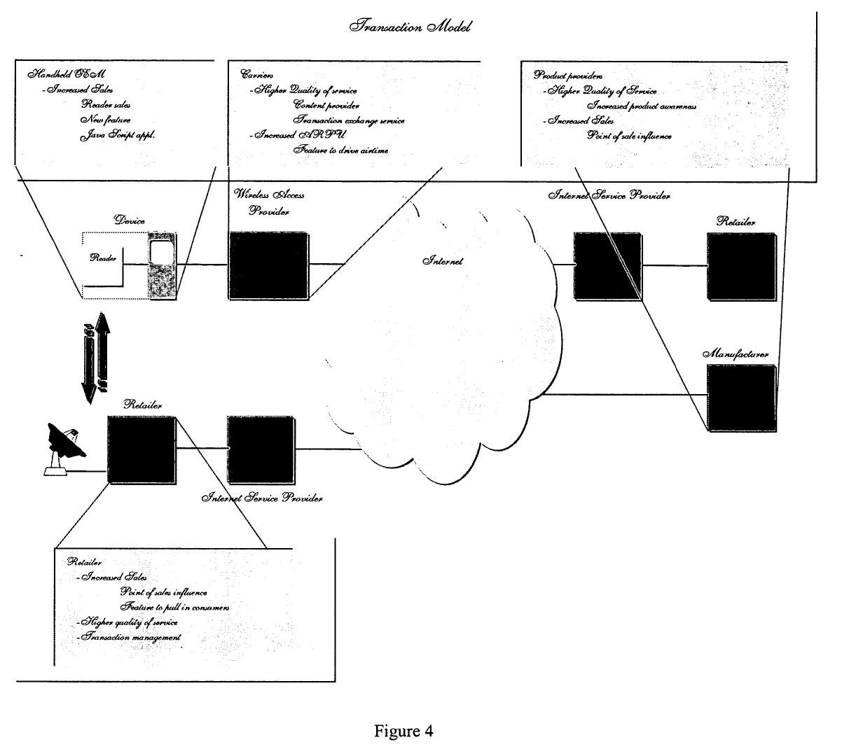

As consumers seamlessly access the system and acquire content within the system, manufacturers can receive or influence point of sale consumer preferences. This advanced tool will allow for immediate reaction by the manufacturer to the consumer. Each and every access by the consumer can be monitored and different marketing elements can be evaluated in real time. This allows for a new service to be offered to leverage this capability and provide unprecedented service to the consumer as well as the manufacturers. To support this capability, the business will develop and offer marketing campaigns and content as a value added service, as well as data base management software to manage content and transactions, as detailed in FIG. 4. This software will be able to operate on large systems as well as personal computers/servers for smaller businesses. This marketing service offering is flexible. The software will be used to create and manage the database for content management. The software will also contain unique market monitor features to adjust and modify any campaign based upon the preference knowledge base created. Software will organize a database with content and operate the appropriate client to access the network elements. This software will allow for data base adjustments or adding elements such as e-coupons at any time. The manufacturers would conduct their own marketing programs through the client software as needed.

The following section uses the business diagram, FIG. 3, to discuss the benefits and opportunity available to each entity within the system for each environment created. It is important to recognize some of the transactions that take place within the environments and possible alternative capabilities never before available. In general, each entity will benefit from the increased service capabilities.

One of the most important features within each of the environments is the ability to provide the individual consumer with information at the time of a purchase decision. The goal of the retailer is to increase sales, while the goal of the manufacturer would be to influence the product selection. The service provider would benefit through increased usage on their system and access to the mobile consumer. The mobile consumer benefits by obtaining information pertaining to desired decision points and the satisfaction of making an educated purchase.

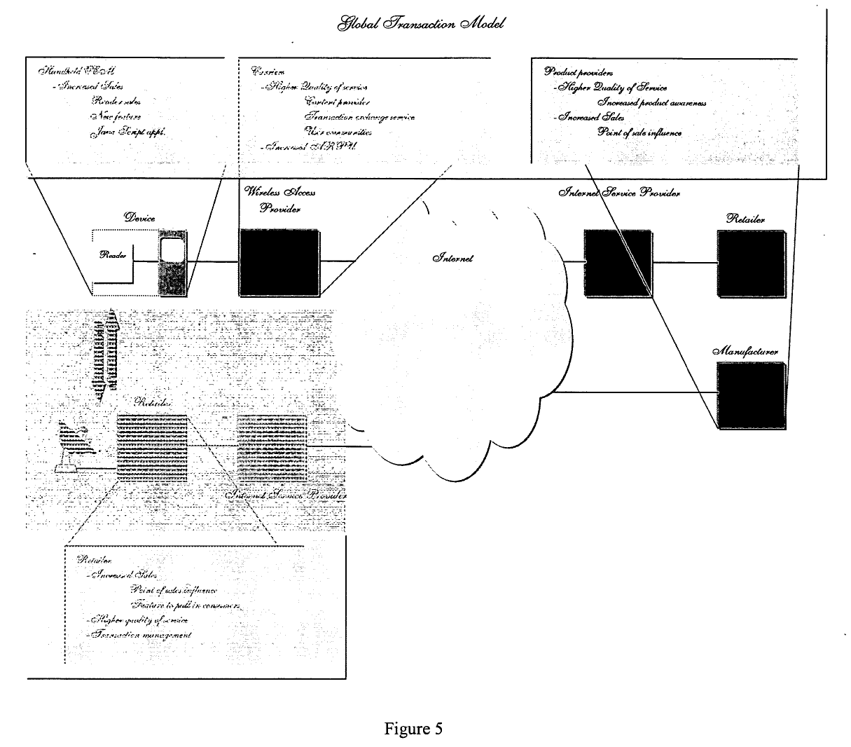

The Global environment is outline in the diagram of FIG. 5. This environment provides the greatest opportunity to create and present individual marketing information and has the most to gain from this unique ability. Having the capability to influence a decision at the point of sale, in real-time and dynamically is unique to this technology and valuable to the global environment. This capability can increase sales, awareness and service to a high level. The global participant, through this unique marketing service, will realize increased sales revenue, either through increased sales or through perceived increased product value where greater consumer awareness allows for optimum product pricing or sales margin.

Further, this technology enables the ability to conduct transactions more efficiently and to better optimize products for the consumer. Efficiency, and the resulting cost savings, would be available through better channel management and product availability. Product optimization can be achieved through individual marketing campaigns and real-time feedback, resulting in better sales for any business entity.

Overall, the system outlined, provides enhanced revenue opportunities for businesses by accelerating consumer purchases in the market.

Although the invention has been described in terms of exemplary embodiments, it is not limited thereto. It will also be appreciated that a system in accordance with the invention can be constructed in whole or in part from special purpose hardware or from conventional general purpose hardware or any combination thereof, any portion of which may be controlled by a suitable program. Any program may in whole or in part comprise part of or be stored on a system in a conventional manner, or remain whole or in part be provided into the system over a network or other mechanism for transferring information in a conventional manner. Accordingly, it is understood that the above description of the present invention is susceptible to considerable modifications, changes and adaptation by those skilled in the art, and that such modifications, changes and adaptations are intended to be considered within the scope of the present invention, which is set forth by the appended claims. The invention having been described, it will be apparent to those skilled in the art that the same may be varied in many ways without departing from the spirit and scope of the invention. Any and all such modifications are intended to be included within the scope of the following claims.

What is claimed is:

1. A method for accessing and displaying data through a portable wireless device by creating a wireless link that is configured at a location for a product or service of interest, comprising:
Providing a wireless identification tag containing information regarding a product or service;
Providing a first wireless interface for accessing the information contained in the wireless identification tag; and
Providing a second wireless interface for accessing or connecting to other remote information regarding the product or service.

2. A method of claim 1, further comprising monitoring of the information accessed by the first wireless interface contained in the wireless identification tag and other remote information accessed or connected to via the second wireless interface.

3. A method of claim 2, wherein monitoring occurs in real time and the information and other remote information accessed or connected to is evaluated to identify consumer preferences for subsequent marketing efforts.

4. A method of claim 3, wherein marketing efforts are targeted to specific consumers based on the information and other remote information accessed or connected to by a consumer in prior transactions.

5. A method of claim 1, further comprising charging a fee for service.

6. A method of claim 1, further comprising authorizing purchases of products or services electronically.

7. A method for accessing data through a portable wireless device by creating a wireless link that is configured at a location for a product or service of interest, comprising:
Providing a wireless identification tag containing information regarding a product or service;
Providing one or more wireless interfaces for accessing the information contained in the wireless identification tag and for accessing other remote information regarding the product or service.

8. A method of claim 7, further comprising monitoring of the information accessed in the wireless radio identification tag and other remote information accessed.

9. A method of claim 8, wherein monitoring occurs in real time and the information and other remote information accessed is evaluated to identify consumer preferences for subsequent marketing efforts.

10. A method of claim 9, wherein marketing efforts are targeted to specific consumers based on the information and other remote information accessed by a consumer in prior transactions.

11. A method of claim 10, further comprising charging a fee for service.

12. A method of claim 11, further comprising authorizing purchases of products or services electronically.

13. A method of claim 9, wherein a service is provided to create marketing channels to a portable wireless consumer to provide one or more of product information, incentive, or special offer.

14. A method of claim 13, further comprising software to create a marketing campaign for manufacturers to offer interactive, dynamic capabilities based on consumer choices.

15. A method of claim 14, further comprising linking consumer choices to RFID tag information.
